(19) United States
(12) Patent Application Publication
(10) Pub. No.: US 2024/0424491 A1
(43) Pub. Date: Dec. 26, 2024

(54) MICROFLUIDIC CHIP FOR SAMPLE PREPARATION AND SAMPLE PREPARATION SYSTEM INCLUDING SAME

(71) Applicant: Agency for Science, Technology and Research, Singapore (SG)

(72) Inventors: Xuezhi BI, SIngapore (SG); Ruige WU, Singapore (SG); Pinhui LEE, Singapore (SG); Ke GAN, Singapore (SG)

(21) Appl. No.: 18/703,263

(22) PCT Filed: Oct. 12, 2022
(86) PCT No.: PCT/SG2022/050729

§ 371 Date: Apr. 19, 2024

(30) Foreign Application Priority Data
Oct. 21, 2021 (SG) 10202111687S

(51) Int. Cl. B01L 3/00

(52) U.S. Cl. CPC B01L 3/502715; B01L 3/502738; B01L 3/502746; B01L 2200/0605; B01L 2200/16; B01L 2300/0816; B01L 2300/0867; B01L 2300/087; B01L 2400/0487; B01L 2400/0688

(57) ABSTRACT

A microfluidic chip (12) for sample preparation and a sample preparation system (10) are provided. The microfluidic chip (10) includes: a chip body (14) and a plurality of injection ports (16, 18, 24, 30, 36, 38, 40) provided in the chip body (14). A plurality of chambers (20, 26, 32) and a plurality of mixers (22, 28, 34) are provided in the chip body (14). A first chamber (20) is configured to receive a sample via a first injection port (16) and a reducing agent via a second injection port (18). A first mixer (22) in fluid communication with the first chamber (20) is operable to mix the sample and the reducing agent from the first chamber (20) to produce a denatured and reduced sample. A second chamber (26) in fluid communication with the first mixer (22) is configured to receive an alkylating agent via a third injection port (24). A second mixer (28) in fluid communication with the second chamber (26) is operable to mix the denatured and reduced sample with the alkylating agent to produce an alkylated sample. A third chamber (32) in fluid communication with the second mixer (28) is configured to receive a protein precipitation solution via a fourth injection port (30). A third mixer (34) in fluid communication with the third chamber (32) is operable to mix the alkylated sample with the protein precipitation solution to produce a precipitated sample. A reaction chamber (42) in fluid communication with the third mixer (34) is provided in the chip body (14), the reaction chamber (42) being configured to receive a washing buffer via a fifth injection port (36), a digestion buffer via a sixth injection port (38) and an elution buffer via a seventh injection port (40). A depth filter (43) is received in the reaction chamber (42). A first discharge port (44) and a second discharge port (46) are provided in the chip body (14) in fluid communication with the reaction chamber (42). The first discharge port (44) is operable to discharge waste from the reaction chamber (42) and the second discharge port (46) is operable to discharge a prepared sample.

### FIELD OF THE INVENTION

The present invention relates in general to proteomics sample preparation and more particularly to a microfluidic chip for sample preparation and a sample preparation system including the same.

### BACKGROUND OF THE INVENTION

Identifying and characterising biological molecules using mass spectrometry (MS) is a fundamental technology in protein biochemistry and proteomic analysis. In current biopharma and food manufacturing setups, majority of protein analytical testing required for process, environmental or contaminant monitoring, quality attributes and impurity characterization of food and drug substances or drug products is performed off-line by mass spectrometry. Off-line analysis requires sample collection, labelling, transportation to a quality control (QC) laboratory, sample receipt and logging, sample preparation, testing and communication of results. The entire process is inefficient and time consuming.

One key bottleneck for sample preparation is trypsin digestion of proteins, which requires a long time for protein quantification, denaturation, reduction, alkylation, desalting and buffer exchange, tryptic enzyme reaction, peptide extraction and subsequent cleaning and concentration, typically from at least 4 hours to overnight in most protocols. Besides being time consuming, trypsin digestion of proteins is also labour intensive. Additionally, use of spin columns or cartridges with size exclusion or molecular cut-off membrane for buffer exchange is also challenging to automate using current autosamplers. Most available automated protein digestion solutions rely on separated or independent modular liquid handler systems, still require manual transfers for vacuum concentrator drying and reconstitution and loading to liquid chromatography-mass spectrometry (LC-MS) instruments, and are not able to support full automation and integration with upstream and downstream sample preparation and subsequent MS analysis.

In any bioanalytical workflow, sample preparation is key to success and achieving precise and accurate testing results. According to statistical data, 61% of time is spent on sample preparation and 30% of errors are linked to sample preparation.

In view of the foregoing, it would be desirable to provide a microfluidic chip for sample preparation and a sample preparation system including the same that automates sample preparation to move protein therapeutics quality testing out of QC laboratories (off-line analysis) to manufacturing floors (in-line, on-line or at-line monitoring) to meet demands for real-time release and shorten time-to-market.

### SUMMARY OF THE INVENTION

Accordingly, in a first aspect, the present invention provides a microfluidic chip for sample preparation. The microfluidic chip includes a chip body, a first injection port provided in the chip body, a second injection port provided in the chip body, and a first chamber provided in the chip body, the first chamber being configured to receive a sample via the first injection port and a reducing agent via the second injection port. A first mixer in fluid communication with the first chamber is provided in the chip body, the first mixer being operable to mix the sample and the reducing agent from the first chamber to produce a denatured and reduced sample. A third injection port is provided in the chip body. A second chamber in fluid communication with the first mixer is provided in the chip body, the second chamber being configured to receive an alkylating agent via the third injection port. A second mixer in fluid communication with the second chamber is provided in the chip body, the second mixer being operable to mix the denatured and reduced sample with the alkylating agent to produce an alkylated sample. A fourth injection port is provided in the chip body. A third chamber in fluid communication with the second mixer is provided in the chip body, the third chamber being configured to receive a protein precipitation solution via the fourth injection port. A third mixer in fluid communication with the third chamber is provided in the chip body, the third mixer being operable to mix the alkylated sample with the protein precipitation solution to produce a precipitated sample. A fifth injection port, a sixth injection port and a seventh injection port are provided in the chip body. A reaction chamber in fluid communication with the third mixer is provided in the chip body, the reaction chamber being configured to receive a washing buffer via the fifth injection port, a digestion buffer via the sixth injection port and an elution buffer via the seventh injection port. A depth filter is received in the reaction chamber. A first discharge port and a second discharge port are provided in the chip body in fluid communication with the reaction chamber. The first discharge port is operable to discharge waste from the reaction chamber and the second discharge port is operable to discharge a prepared sample.

In a second aspect, the present invention provides a sample preparation system. The sample preparation system includes the microfluidic chip in accordance with the first aspect, a syringe pump connected to a plurality of the injection ports of the microfluidic chip, and a microcontroller configured to control reagent quantities dispensed by the syringe pump via the injection ports.

Other aspects and advantages of the invention will become apparent from the following detailed description, taken in conjunction with the accompanying drawings, illustrating by way of example the principles of the invention.

### BRIEF DESCRIPTION OF THE DRAWINGS

Embodiments of the invention will now be described, by way of example only, with reference to the accompanying drawings, in which:

FIG. 1 is a schematic diagram illustrating a sample preparation system including a microfluidic chip for sample preparation in accordance with embodiments of the present invention;

FIG. 2 is a schematic block diagram of a control system of the sample preparation system of FIG. 1;

FIGS. 3A through 3C are schematic diagrams illustrating a plurality of injection port of the microfluidic chip of FIG. 1;

FIGS. 4A through 4C are schematic diagrams illustrating a reaction chamber of the microfluidic chip of FIG. 1; and

FIG. 5 is a schematic flow diagram illustrating a process flow of the sample preparation system of FIG. 1.

### DETAILED DESCRIPTION OF EXEMPLARY EMBODIMENTS

The detailed description set forth below in connection with the appended drawings is intended as a description of presently preferred embodiments of the invention, and is not intended to represent the only forms in which the present invention may be practiced. It is to be understood that the same or equivalent functions may be accomplished by different embodiments that are intended to be encompassed within the scope of the invention.

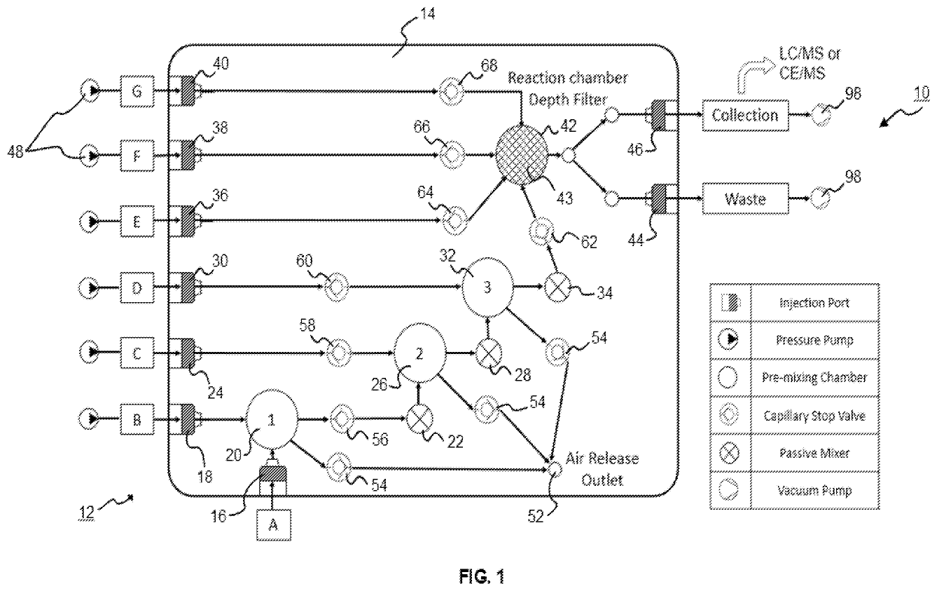

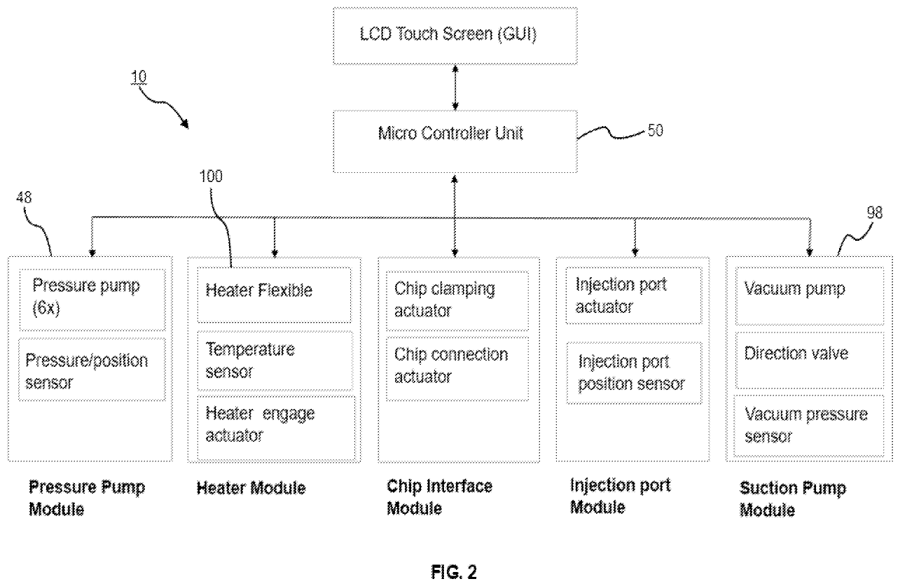

Referring now to FIGS. 1 and 2, a sample preparation system 10 including a microfluidic chip 12 for sample preparation is shown.

The microfluidic chip 12 for sample preparation includes a chip body 14 and first and second injection ports 16 and 18 provided in the chip body 14. A first chamber 20 is provided in the chip body 14 and is configured to receive a sample via the first injection port 16 and a reducing agent via the second injection port 18. A first mixer 22 is provided in the chip body 14 and is in fluid communication with the first chamber 20, the first mixer 22 being operable to mix the sample and the reducing agent from the first chamber 20 to produce a denatured and reduced sample. A third injection port 24 and a second chamber 26 are provided in the chip body 14. The second chamber 26 is in fluid communication with the first mixer 22 and is configured to receive an alkylating agent via the third injection port 24. A second mixer 28 is provided in the chip body 14 and is in fluid communication with the second chamber 26, the second mixer 28 being operable to mix the denatured and reduced sample with the alkylating agent to produce an alkylated sample. A fourth injection port 30 and a third chamber 32 are provided in the chip body 14. The third chamber 32 is in fluid communication with the second mixer 28 and is configured to receive a protein precipitation solution via the fourth injection port 30. A third mixer 34 is provided in the chip body 14 and is in fluid communication with the third chamber 32, the third mixer 34 being operable to mix the alkylated sample with the protein precipitation solution to produce a precipitated sample. Fifth, sixth and seventh injection ports 36, 38 and 40 and a reaction chamber 42 are provided in the chip body 14. The reaction chamber 42 is in fluid communication with the third mixer 34 and is configured to receive a washing buffer via the fifth injection port 36, a digestion buffer via the sixth injection port 38 and an elution buffer via the seventh injection port 40. A depth filter 43 is received in the reaction chamber 42. First and second discharge ports 44 and 46 in fluid communication with the reaction chamber 42 are provided in the chip body 14. The first discharge port 44 is operable to discharge waste from the reaction chamber 42 and the second discharge port 46 is operable to discharge a prepared sample.

As can be seen from FIG. 1, processed protein/peptide samples are ready for mass spectrometry analysis, without requiring extra cleaning such as desalting and concentrating steps via offline speed vacuum centrifugation and reconstitution in liquid chromatography-mass spectrometry (LC-MS) loading buffers.

The integrated microfluidics chip 12 is reusable for multiple times and may be used for automated, online sample preparation in a continuous-flow process. The reaction chamber 42 may be regenerated for multiple sample processing for up to 14 days of feed batch bioreactor run duration provided sampling once a day.

The sample preparation system 10 includes a syringe pump 48 connected to a plurality of the injection ports 18, 24, 30, 36, 38 and 40 of the microfluidic chip 12 and a microcontroller 50 configured to control reagent quantities dispensed by the syringe pump 48 via the injection ports 18, 24, 30, 36, 38 and 40. Advantageously, this allows precise volumes of reagents required for each step to be continuously in-fused into the microfluidic chip 12 via the syringe pump 48.

An air release outlet 52 in fluid communication with the first, second and third chambers 20, 26 and 32 may be provided in the chip body 14.

A plurality of first capillary stop valves 54 may be provided in the chip body 14, each of the first capillary stop valves 54 being in fluid communication between a corresponding one of the first, second and third chambers 20, 26 and 32 and the air release outlet 52.

A second capillary stop valve 56 in fluid communication between the first chamber 20 and the first mixer 22 may be provided in the chip body 14.

A third capillary stop valve 58 in fluid communication between the third injection port 24 and the second chamber 26 may be provided in the chip body 14.

A fourth capillary stop valve 60 in fluid communication between the fourth injection port 30 and the third chamber 32 may be provided in the chip body 14.

A fifth capillary stop valve 62 in fluid communication between the third mixer 34 and the reaction chamber 42 may be provided in the chip body 14.

A sixth capillary stop valve 64 in fluid communication between the fifth injection port 36 and the reaction chamber 42 may be provided in the chip body 14.

A seventh capillary stop valve 66 in fluid communication between the sixth injection port 38 and the reaction chamber 42 may be provided in the chip body 14.

An eighth capillary stop valve 68 in fluid communication between the seventh injection port 40 and the reaction chamber 42 may be provided in the chip body 14.

At least one of the mixers 22, 28 and 34 may be a passive mixer.

Advantageously, the capillary stop valves 54, 56, 58, 60, 62, 64, 66 and 68 and the passive mixer do not engage any embedded material that may introduce undesired cross-over or increase manufacturing cost. Because the capillary stop valves 54, 56, 58, 60, 62, 64, 66 and 68 and the passive mixer do not require any built-in components, manufacturing cost and residue/carry-overs may be reduced.

Further advantageously, use of passive mixing and the capillary stop valves 54, 56, 58, 60, 62, 64, 66 and 68 together with the syringe pump 48 facilitates precise manipulation of reagents for sequential steps of protein/peptide preparation.

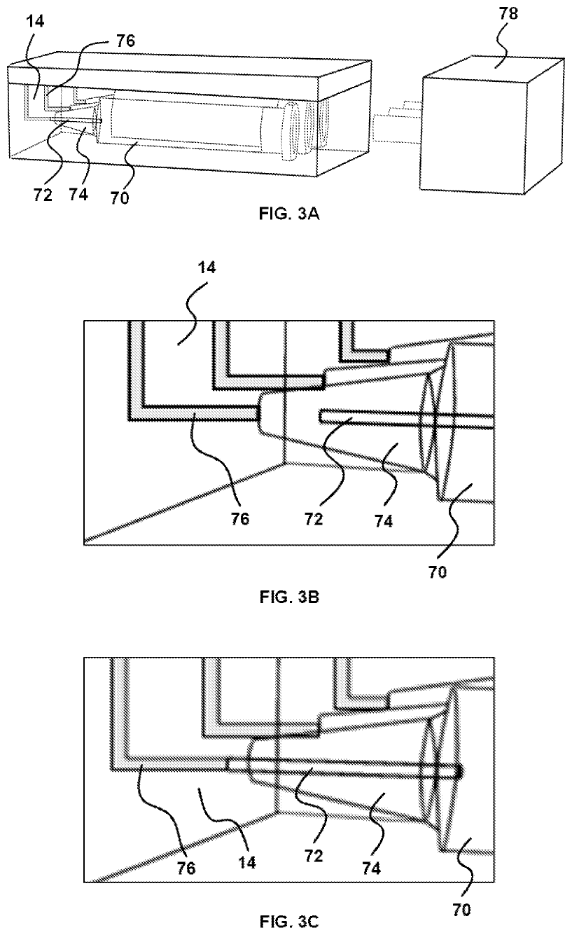

Referring now to FIGS. 3A through 3C, at least one of the injection ports 16, 18, 24, 30, 36, 38 and 40 or the discharge ports 44 and 46 includes a syringe 70, a needle 72 attached to the syringe 70, and a gasket 74 attached to a fluid channel 76 in the chip body 14, the needle 72 being received in the gasket 74. The needle 72 may be a hypodermic needle and the gasket 74 may be a resealable gasket.

As can be seen from FIGS. 3B and 3C, the syringe 70 is operable to move the needle 72 between a first position as shown in FIG. 3B where the needle 72 is disengaged from the fluid channel 76 in the chip body 14 and a second position as shown in FIG. 3C where the needle 72 engages the fluid channel 76 in the chip body 14. More particularly, when the syringe or tubing 70 with the needle 72 is engaged/loaded to the microfluidic chip 12 by a control system 78, the needle 72 pierces the gasket 74 and this allows flow to pass through as shown in FIG. 3C. When the syringe or tubing 70 is unloaded/released by the control system 78, the gasket 74 is self-sealed as shown in FIG. 3B.

Advantageously, the injection ports 16, 18, 24, 30, 36, 38 and 40 and the discharge ports 44 and 46 in such an embodiment are assembled to the microfluidic chip 12 and provide a chip-to-system interface to support continuous-flow and multiple sample processing. Solutions may be injected into/pulled from the microfluidic chip 12 through the syringe or tubing 70 attached to the needle 72 after piercing the resealable gasket 74. In such an embodiment, all waste may be directly transferred to a waste container through the first discharge port 44. The second discharge port 46 in such an embodiment facilitates direct injection of eluted protein, subunit or peptide to a liquid chromatography (LC) or capillary electrophoresis (CE) coupled mass spectrometer for sample analysis without further offline sample speed vacuum concentrating and cleaning.

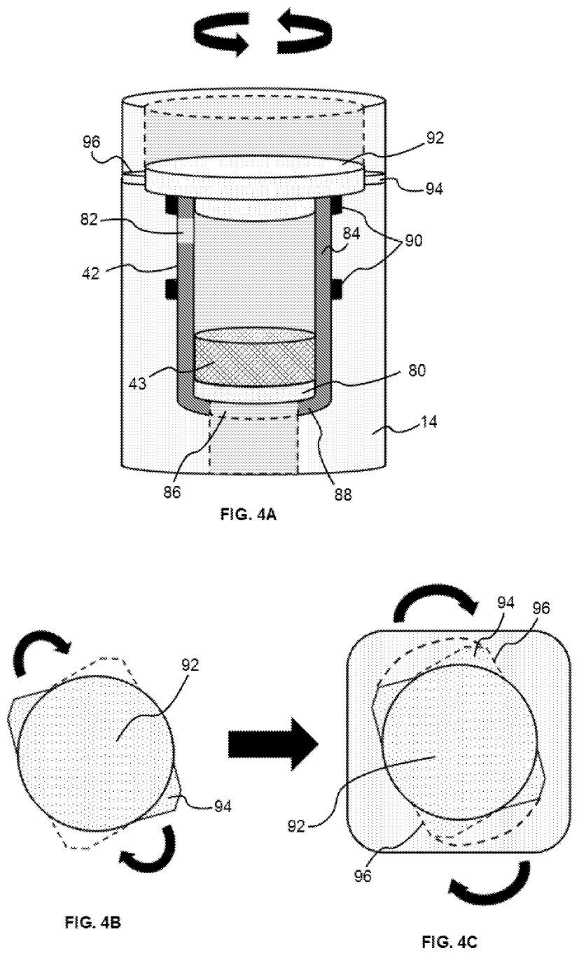

Referring now to FIGS. 4A through 4C, the reaction chamber 42 includes an inlet 82 on a side surface 84 and an outlet 86 on a base surface 88. The inlet 82 on the side surface 84 allows inflow of buffer solutions into the reaction chamber 42. The buffer solutions then flow through the depth filter 43 before leaving the reaction chamber 42 via the outlet 86 on the base surface 88 in alignment with an outlet channel in the chip body 14. Advantageously, the reaction chamber 42 is replaceable in such an embodiment.

A filter frit 80 may be provided in the reaction chamber 42 between the depth filter 43 and the outlet 86 on the base surface 88 of the reaction chamber 42 to filter out solid particles, precipitate or residue from the buffer solutions leaving the reaction chamber 42.

A plurality of O-rings 90 may be provided around the side surface 84 of the reaction chamber 42, the O-rings 90 being wedged between the chip body 14 and the reaction chamber 42. Advantageously, the O-rings 90 help to secure the reaction chamber 42 to the chip body 14 of the microfluidic chip 12. In the embodiment shown, two (2) O-rings 90 are provided. However, it should be appreciated by those of ordinary skill in the art that the present invention is not limited by the number of O-rings 90 used. In alternative embodiments, fewer or greater numbers of O-rings 90 may be used.

A cap 92 may be removably attached to an opening of the reaction chamber 42, the cap 92 having a plurality of protruding edges 94 configured to be correspondingly received in a plurality of grooves 96 in the chip body 14. The cap 92 seals the depth filter 43 in the reaction chamber 42. The reaction chamber 42 and the cap 92 form a replaceable reaction chamber accessory. After placement of the reaction chamber 42 into the microfluidic chip 12, the cap 92 may be locked into position in the chip body 14 with a 90° turn in a clockwise direction.

Referring again to FIGS. 1 and 2, the sample preparation system 10 may include a plurality of suction pumps 98 connected to the first and second discharge ports 44 and 46, the microcontroller 50 being configured to control operation of the suction pumps 98 to drain the reaction chamber 42.

A flexible heater 100 may be received in the reaction chamber 42, the flexible heater 100 being operable to maintain a predetermined temperature in the reaction chamber 42 when in use. More particularly, the flexible heater 100 may be loaded to a bottom of the reaction chamber 42 during operation to heat a mixture of sample and reagents (denaturation, reduction and alkylation) to the predetermined temperature of, for example, about 37° C. and to maintain the reaction chamber 42 at the predetermined temperature during a reaction process. After that, the flexible heater 100 may be unloaded from the reaction chamber 42 and the reaction chamber 42 may be cooled down to room temperature by pumping air into it. The microcontroller 50 may be configured to control operation of the flexible heater 100 to maintain a processing temperature in the reaction chamber 42 at the predetermined temperature. Advantageously, this facilitates integrated denaturation, reduction and alkylation of protein sample at 37° C. and also 0.1% surfactant enhanced protease or deglycosylation enzyme treatment of captured proteins on the depth filter 43 at 37° C. for a short period of time to minimize artificial post-translational modification such as deamidation.

The microcontroller 50 may be separately housed in a control system together with a pump module, a heater module and an interface module. Modular flow rate and valve switch or temperature control or built-in flow direction/valve control may thus be externally provided. Automated valve control may be implemented using the controller 50. The syringe pump module provides reagents infusion to the microfluidic chip 12 for multiple processing steps, while the suction pump module provides required positive and negative pressure for thorough depletion of the reaction chamber 42 before applying new reagents to it. The heater module maintains the required temperature for enzymatic reactions, while the interface module controls the loading/unloading of the microfluidic chip 12 to the sample preparation system 10 and reagents from/to the microfluidic chip 12 via the injection ports 18, 24, 30, 36, 38 and 40.

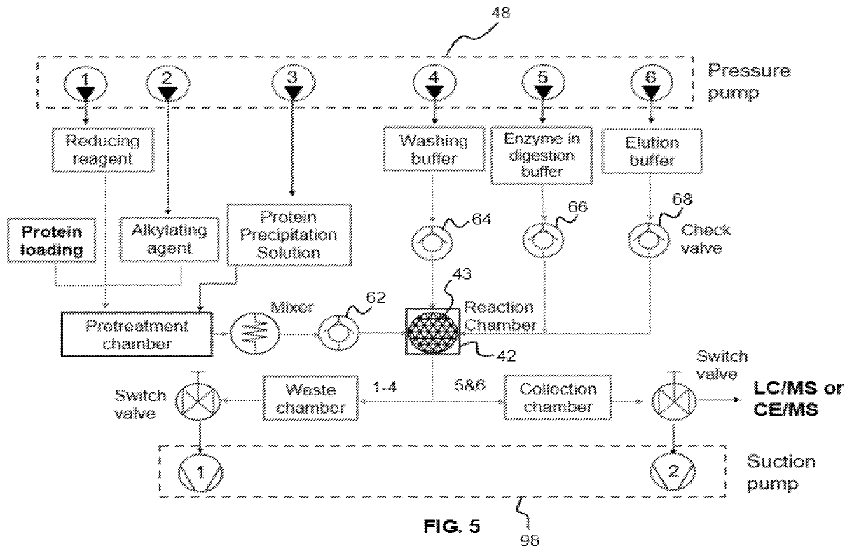

Referring now to FIG. 5, an automated, online sample preparation process using the sample preparation system 10 including the continuous-flow microfluidic chip 12 of FIGS. 1 and 2 will now be described. Using the microfluidic chip 12, the automated, online sample preparation process may include steps of: integrated denaturation, reduction and alkylation of a protein sample at between about 37 degrees Celsius (° C.) and about 50° C.; precipitation of proteins in the sample in a protein precipitation solution containing a mixture of organic solvents such as acetonitrile/methanol/isopropanol in an optimal ratio to control proper particle size without the requirement of sodium dodecyl sulphate (SDS)—phosphoric acidification-methanolic solution; capturing of the precipitated proteins in the reaction chamber 42 and a washing buffer for buffer exchange and enzyme reaction; 0.1% surfactant enhanced protease or deglycosylation enzyme treatment of the captured proteins in the reaction chamber 42 at 37° C. for a short period of time to minimize artificial posttranslational modification such as deamidation; elution of the protein fragments, subunit or peptide digest from the reaction chamber 42; and direct injection of the eluted protein, subunit or peptide to a liquid chromatography (LC) or capillary electrophoresis (CE) coupled mass spectrometer for sample analysis without further offline sample speed vacuum concentrating and cleaning.

Advantageously, the microfluidic chip 12 may be used in an online process, without offline steps being introduced.

Further advantageously, no high temperature heat is required as temperature control is maintained at about 37° C. The enzymatic reaction is carried out at 37° C. in the flow-controlled reaction chamber 42 (exchangeable).

The microfluidic chip 12 combines protein sample denaturation, reducing and alkylation in reagent in one step without sodium dodecyl sulphate (SDS) and high temperature heating. This is followed by balanced cocktail organic solvents (acetonitrile/methanol/isopropanol) precipitation and buffer exchange in the reaction chamber 42 without requirement of SDS-phosphoric acidification-methanolic solution for colloidal particulate formation. Online protein capture and buffer exchange is achieved by protein precipitation using only a cocktail of optimized organic solvents to control particle size, instead of SDS-acid-alcoholic articulation, followed by use of a washing buffer on a flow-controlled reaction chamber 42 without offline centrifugation. After protease enzyme digestion, peptide/protein fragments are directly quenched and eluted with acid and acetonitrile (ACN) and then the sample is ready for liquid chromatography-mass spectrometry (LC-MS) analysis, without requiring offline centrifuge and sample speed vacuum concentrating and cleaning, which significantly reduces the sample preparation steps and time, while enhancing protein recovery and mass spectrometry (MS) peptide coverage performance. No acidification or SDS is required for protein precipitation/particulation using the microfluidic chip 12; precipitation of proteins may be performed using the microfluidic chip 12 without acidification and SDS for proper particle size.

To realize multiple steps on a single microfluidic chip 12, precise fluidic manipulation between steps is required so that reactions can be controlled (stopped or allowed to happen) automatically, instead of by manual intervention.

Use of external auto-controlled switch valves, instead of chip built-in switch valves, also significantly reduces chip manufacturing cost and eliminates cross-over and residue issues caused by chip built-in valves.

As is evident from the foregoing discussion, the present invention provides a microfluidic chip for sample preparation and a sample preparation system including the same that automates sample preparation. Advantageously, automation of the sample preparation process increases productivity, throughput and accuracy as well as robustness and consistency, reduces human error and operational inconsistency, and provides cost savings. The present invention transforms manual labour intensive and time-consuming offline sample processing into an automated online sample preparation device that can perform protein denaturation/reduction/alkylation, buffer exchange, enzymatic reaction, fragment and peptide elution, and can then be linked directly to a mass spectrometer for online analysis. Peptide preparation involves procedures such as reduction and alkylation of cysteines, digestion of a protein sample into peptides, desalting and concentration of the peptides and final analysis of these peptides by mass spectrometry, all of which can be integrated into a proteomics microfluidics reusable chip device in the present invention. The present invention may be miniaturised into a microfluidic microchip. The microfluidic chip of the present invention may be connected to a ready flow injector for automation and the sample preparation system of the present invention may be easily integrated with other liquid chromatography (LC) systems and controlled through a third-party software interface. The microfluidic chip of the present invention incorporates a robust and fast proteomics sample preparation workflow, consisting of protein denaturation, reduction, alkylation and enzyme reaction from which processed samples can be subsequently analysed directly by mass spectrometry without extra cleaning steps. Advantageously, this reduced a whole sampling process duration to approximately one (1) hour. The present invention enables automation for online sample processing to facilitate real-time characterization of biopharmaceutics quality attributes using a different mechanism of protein precipitation method (mixture of organic solvents), without a high concentration of SDS, phosphoric acid acidification methanolic solution.

The microfluidic chip for sample preparation and the sample preparation system including the same may be used to prepare proteins and peptides for mass spectrometry analysis. The microfluidic chip for sample preparation and the sample preparation system including the same may be used by biopharma manufacturers in biopharma bioanalytics for biotherapeutics quality attributes online real-time characterization, online process monitoring of biologics during bioproduction processes, biotherapeutical protein quality control (QC) characterization and at line real-time analysis of product quality attributes by mass spectrometry. The proteomics microfluidics chip device of the present invention allows real-time online characterization and monitoring of critical quality attributes (CQAs) of monoclonal antibodies (mAb) biologics such as intact mass analysis of non-reduced, deglycosylated and reduced subunits, multiple attribute methods-peptide mapping including post-translational modifications of the mAbs as well as the host cell protein profiles with linkage to manufacturing bioreactor or cell culture system. In addition, the microfluidic chip of the present invention may also be used to monitor potential extracellular protein biomarkers as critical process parameters that are predictive of product CQA changes and thus allow for possible development of specific control strategies to rectify any deviations during bioproduction processes. The flow-controlled fluidic microchip device of the present invention enables automation for online sample process to facilitate real-time characterization of biopharmaceutics quality attributes and multiple sample processing to feed a batch bioreactor.

While preferred embodiments of the invention have been described, it will be clear that the invention is not limited to the described embodiments only. Numerous modifications, changes, variations, substitutions and equivalents will be apparent to those skilled in the art without departing from the scope of the invention as described in the claims.

Further, unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

What is claimed is:

1. A microfluidic chip for sample preparation, comprising:
a chip body;
a first injection port provided in the chip body;
a second injection port provided in the chip body;
a first chamber provided in the chip body and configured to receive a sample via the first injection port and a reducing agent via the second injection port;
a first mixer provided in the chip body and in fluid communication with the first chamber, wherein the first mixer is operable to mix the sample and the reducing agent from the first chamber to produce a denatured and reduced sample;
a third injection port provided in the chip body;
a second chamber provided in the chip body and in fluid communication with the first mixer, wherein the second chamber is configured to receive an alkylating agent via the third injection port;
a second mixer provided in the chip body and in fluid communication with the second chamber, wherein the second mixer is operable to mix the denatured and reduced sample with the alkylating agent to produce an alkylated sample;
a fourth injection port provided in the chip body;
a third chamber provided in the chip body and in fluid communication with the second mixer, wherein the third chamber is configured to receive a protein precipitation solution via the fourth injection port;
a third mixer provided in the chip body and in fluid communication with the third chamber, wherein the third mixer is operable to mix the alkylated sample with the protein precipitation solution to produce a precipitated sample;
a fifth injection port provided in the chip body;
a sixth injection port provided in the chip body;
a seventh injection port provided in the chip body;
a reaction chamber provided in the chip body and in fluid communication with the third mixer, wherein the reaction chamber is configured to receive a washing buffer via the fifth injection port, a digestion buffer via the sixth injection port and an elution buffer via the seventh injection port;
a depth filter received in the reaction chamber;
a first discharge port provided in the chip body and in fluid communication with the reaction chamber, the first discharge port being operable to discharge waste from the reaction chamber; and
a second discharge port provided in the chip body and in fluid communication with the reaction chamber, the second discharge port being operable to discharge a prepared sample.

2. The microfluidic chip according to claim 1, further comprising:
an air release outlet provided in the chip body, wherein the air release outlet is in fluid communication with the first, second and third chambers.

3. The microfluidic chip according to claim 2, further comprising:
a plurality of first capillary stop valves provided in the chip body, each of the first capillary stop valves being in fluid communication between a corresponding one of the first, second and third chambers and the air release outlet.

4. The microfluidic chip according to claim 1, further comprising:
a second capillary stop valve provided in the chip body and in fluid communication between the first chamber and the first mixer.

5. The microfluidic chip according to claim 1, further comprising:
a third capillary stop valve provided in the chip body and in fluid communication between the third injection port and the second chamber.

6. The microfluidic chip according to any one of the preceding claim 1, further comprising:
a fourth capillary stop valve provided in the chip body and in fluid communication between the fourth injection port and the third chamber.

7. The microfluidic chip according to claim 1, further comprising:
a fifth capillary stop valve provided in the chip body and in fluid communication between the third mixer and the reaction chamber.

8. The microfluidic chip according to claim 1, further comprising:
a sixth capillary stop valve provided in the chip body and in fluid communication between the fifth injection port and the reaction chamber.

9. The microfluidic chip according to claim 1, further comprising:
a seventh capillary stop valve provided in the chip body and in fluid communication between the sixth injection port and the reaction chamber.

10. The microfluidic chip according to any one of the preceding claim 1, further comprising:
an eighth capillary stop valve provided in the chip body and in fluid communication between the seventh injection port and the reaction chamber.

11. The microfluidic chip according to claim 1, wherein at least one of the mixers is a passive mixer.

12. The microfluidic chip according to claim 1, wherein at least one of the injection ports or the discharge ports comprises:
a syringe;
a needle attached to the syringe; and
a gasket attached to a fluid channel in the chip body, wherein the needle is received in the gasket.

13. The microfluidic chip according to claim 12, wherein the syringe is operable to move the needle between a first position where the needle is disengaged from the fluid channel in the chip body and a second position where the needle engages the fluid channel in the chip body.

14. The microfluidic chip according to claim 1, wherein the reaction chamber comprises an inlet on a side surface and an outlet on a base surface.

15. The microfluidic chip according to claim 14, further comprising a plurality of O-rings around the side surface of the reaction chamber, the O-rings being wedged between the chip body and the reaction chamber.

16. The microfluidic chip according to claim 14, further comprising a cap removably attached to an opening of the reaction chamber, the cap having a plurality of protruding edges configured to be correspondingly received in a plurality of grooves in the chip body.

17. The microfluidic chip according to claim 1, further comprising:
a flexible heater received in the reaction chamber and operable to maintain a predetermined temperature in the reaction chamber when in use.

18. A sample preparation system, comprising:
the microfluidic chip according to any one of the preceding claims;
a syringe pump connected to a plurality of the injection ports of the microfluidic chip; and
a microcontroller configured to control reagent quantities dispensed by the syringe pump via the injection ports.

19. The sample preparation system of claim 18, further comprising:
a plurality of suction pumps connected to the first and second discharge ports, wherein the microcontroller is configured to control operation of the suction pumps to drain the reaction chamber.
